(19) United States
(12) Patent Application Publication
(10) Pub. No.: US 2005/0223555 A1
(43) Pub. Date: Oct. 13, 2005

(54) Method for forming holes, component having holes, and liquid-discharge head

(75) Inventors: Fumiaki Suto, Tokyo (JP); Kazuhiro Aoyama, Kanagawa (JP); Kazuyoshi Ota, Gifu (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 11/010,469

(22) Filed: Dec. 13, 2004

(30) Foreign Application Priority Data
Dec. 15, 2003 (JP) 2003-415867

(51) Int. Cl. B23H 1/04

(52) U.S. Cl. 29/890

(57) ABSTRACT

A method for forming small holes in a workpiece with a press tool (punch) and a female mold (die) of a press machine. The workpiece is positioned on the female mold such that the workpiece is positioned in the horizontal direction. The workpiece is then restrained only in the horizontal direction and is not pressed in the thickness direction of the workpiece. Since the holes are formed while the workpiece is supported without being pressed, reduction in the pitch accuracy due to the relief of the material, generation of burrs in regions around the holes, deformation such as sags, sticking of the material to the punch, etc., are avoided, and high-aspect-ratio, high-pitch-accuracy small holes are formed.

This application claims priority from Japanese Patent Application No. 2003-415867 filed Dec. 15, 2003, which is hereby incorporated by reference herein.

### BACKGROUND OF THE INVENTION

1. Field of the Invention

The present invention relates to a method for forming small holes by mechanical processing to manufacture a component having holes, such as a nozzle plate of a liquid-discharge head, and also relates to the component having holes and the liquid-discharge head.

2. Description of the Related Art

In accordance with development of micromachines and the like, requirements for micromachining technologies have increased. In particular, a process of forming small holes is extremely important since it is one of the basic micromachining techniques, and it is required to form small-diameter, high-aspect-ratio holes with high precision.

A typical device which requires small holes is an on-demand liquid-discharge head having nozzles from which drops of liquid, such as ink, are discharged by a pressure supplied from a pressure-generating device. The pressure-generating device may include a laminate of a pressure-generating member, such as PZT, and a metal or ceramic plate, or may generate the discharge pressure by forming bubbles of vaporized liquid using a heater element which applies thermal energy to the liquid.

Recently, recording apparatuses including such a liquid-discharge head have been used for forming high-precision, high-definition images on a recording medium, such as paper, at high speed, and have come into widespread use in commercial printers and facsimile machines, textile printing, etc., or for industrial use.

In order to form high-precision, high-definition images, a nozzle plate must have small, high-precision holes which function as nozzles for discharging liquid. Accordingly, various methods for forming holes have been suggested.

For example, Japanese Patent Laid-Open No. 60-42054 (corresponding U.S. Pat. No. 4,574,445) discloses a method for forming holes by a mechanical process using a high-precision press machine or the like. According to this method, a commonly used male mold (punch) and a female mold (die) are manufactured with high precision and are used for forming small holes in a workpiece by press forming.

Alternatively, electrical methods, such as electric discharge machining, may also be used. In such a case, a workpiece is fixed on a high-precision stage with a jig and is subjected to electric discharge machining using a discharge generator circuit including an RC circuit which generates electric discharge pulses with small energy.

In addition, Japanese Patent Laid-Open No. 4-312853 discloses a method using chemical machining, such as etching.

However, in a known press forming process, it is difficult to form small holes with a high aspect ratio of more than 1 or 2 since the strength of the punch is limited, and since there is a restriction in that a clearance between the die and the punch must be set with high precision. In addition, since the workpiece is pressed between the molds from above and below, a part of the material of the workpiece is pushed to a region around the hole in relief in the horizontal direction when the punch is inserted, and accordingly the pitch accuracy is reduced when a plurality of small holes are formed.

In addition, in electrical machining, machining marks remain in regions around the holes or in inner walls thereof, and it is difficult to constantly form holes with high shape accuracy since the process is largely affected by processing conditions including environmental factors. In addition, in chemical machining, the pitch accuracy is lower than that obtained by the other methods when a plurality of holes are formed.

In addition, large burrs and sags are unavoidable in any of the above-described methods, and this serves as a barrier to increasing the precision of small holes such as nozzles.

### SUMMARY OF THE INVENTION

The present invention is directed to a method for forming high-pitch-accuracy, high-aspect-ratio small holes with a uniform shape in a workpiece to manufacture a component having holes, such as a nozzle plate of a liquid-discharge head, while reducing relief in the horizontal direction, burrs, and the like. The present invention is also directed to a component and a liquid-discharge head formed by the method of the present invention.

In one aspect of the present invention, a method for forming holes in a workpiece includes: providing a press tool and a female mold; positioning the workpiece on the female mold in a horizontal direction with respect to the female mold; restraining the workpiece on the female mold in the horizontal direction without pressing the workpiece in a thickness direction of the workpiece; and press-forming holes in the workpiece by moving at least one of the press tool or the workpiece into engagement with each other.

In another aspect of the present invention, a component is formed by the above-described method.

In yet another aspect, a liquid-discharge head includes a main unit having a plurality of discharge-energy-generating elements and a plurality of liquid flow paths facilitating ejecting liquid; and a nozzle plate having a plurality of nozzles communicating with the liquid flow paths, wherein the nozzles are formed by the above-described method.

More specifically, in the hole-forming process using the press machine, the workpiece is placed on the female mold (die) of the press machine such that the workpiece is positioned and retained only in the horizontal direction, and small holes having the same shape as the outer shape of the punch are formed by moving the press tool (punch) downward while the workpiece is not pressed in the thickness direction thereof. In one embodiment, the workpiece is restrained by positioning pins. Since the holes are formed while the workpiece is supported without being pressed, reduction in the pitch accuracy due to the relief of the material, generation of burrs in regions around the holes, deformation such as sags, sticking of the material to the punch, etc., are avoided, unlike that case in which the press-forming process is performed while the workpiece is clamped by molds from above and below. Accordingly, high-aspect-ratio, high-pitch-accuracy small holes are formed.

In another embodiment, the workpiece is restrained by suction. When the workpiece is held on the female mold by suction using a suction unit, the workpiece on the female mold can be tightly held without being pressed, and the deformation in the regions around the small holes is more effectively prevented.

Accordingly, a super-fine liquid-discharge head having stable discharge performance is obtained by forming nozzles in the nozzle plate using the above-described hole-forming process.

Further features and advantages of the present invention will become apparent from the following description of the embodiments with reference to the attached drawings.

### BRIEF DESCRIPTION OF THE DRAWINGS

FIG. 1A is a sectional view showing a main part of a liquid-discharge head according to an embodiment of the present invention, and FIG. 1B is an exploded perspective view of the liquid-discharge head in which a nozzle plate is separated from a main body.

FIGS. 2A to 2C are diagrams showing a hole-forming method according to a first example.

FIG. 3 is a diagram showing a hole-forming method according to a second example.

FIG. 4 is a diagram showing a hole-forming method according to a third example.

FIG. 5 is a diagram showing a hole-forming method according to a fourth example.

FIG. 6 is a diagram showing a hole-forming method according to a fifth example.

FIG. 7 is a diagram showing the manner in which a workpiece is deformed when it is processed.

FIG. 8 is a diagram showing a hole-forming method according to a sixth example.

FIG. 9 is a diagram showing a hole-forming method according to a seventh example.

FIG. 10 is a diagram showing a method for removing burrs after holes are formed by the method according to the seventh example.

### DESCRIPTION OF THE EMBODIMENTS

The present invention will be described in detail below with reference to the accompanying drawings.

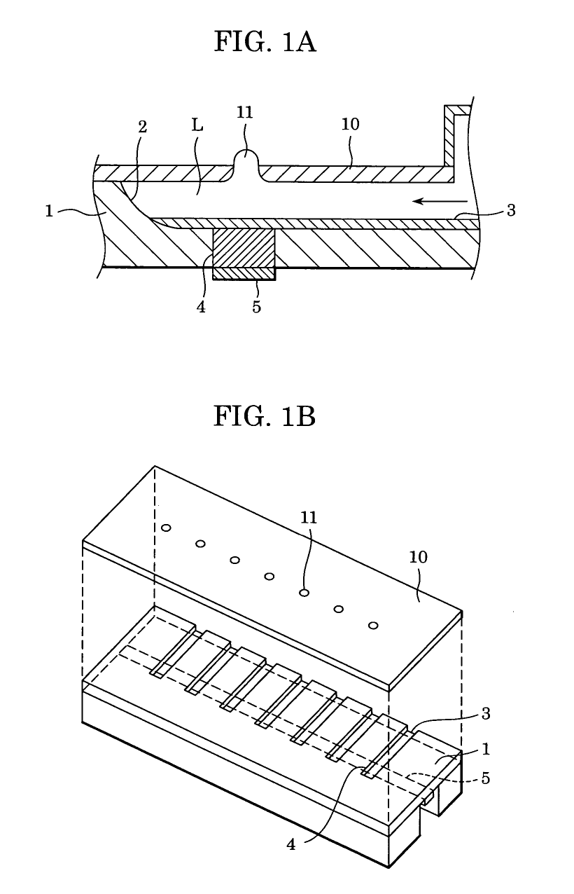

FIGS. 1A and 1B are diagrams showing a liquid-discharge head according to an embodiment of the present invention. The liquid-discharge head includes a main body having a substrate 1 in which a plurality of grooves 2 are formed, the grooves 2 serving as liquid flow paths including pressurizing cells, first electrodes 3 adhered to the bottom surfaces of the grooves 2, piezoelectric elements 4 provided in the substrate 1 and serving as discharge-energy-generating elements, and a second electrode 5 provided on the bottom surfaces of the piezoelectric elements 4. In addition, the liquid-discharge head also includes a nozzle plate 10 laminated on the main body so as to cover the grooves 2 and serving as a component having holes. The nozzle plate 10 has nozzles 11, which are small holes opening into the respective grooves 2.

Liquid L, such as ink, is supplied in the direction shown by the arrow in FIG. 1A, and is pressurized due to the strain of each piezoelectric element 4 caused by a voltage applied between the electrodes 3 and 5. Accordingly, the liquid L is discharged from the corresponding nozzle 11 of the nozzle plate 10 in the form of a liquid drop.

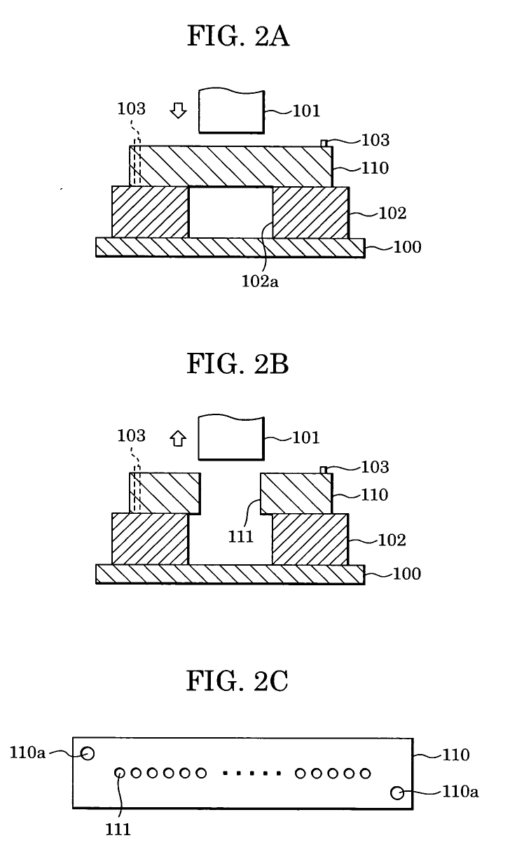

FIGS. 2A to 2C are diagrams showing a small-hole-forming process using a press machine for manufacturing the above-described nozzle plate having the nozzles. A punch 101, which serves as a press tool, is moved downward towards a stage 100 to press a workpiece 110 (a material of the nozzle plate) placed on a female mold 102, and thus a small hole 111, which serves as a nozzle, is formed. In this process, a pair of positioning pins 103 which stand upright on the stage 100 are fitted into positioning holes 110a provided at both ends of the workpiece 110 and the bottom surface of the workpiece 110 is brought into tight contact with the top surface of the female mold 102 in a region around an opening 102a, so that the workpiece 110 is positioned in the horizontal direction. Accordingly, a hole is formed by moving the punch 101 downward while the workpiece 110 on the female mold 102 is restrained by the positioning pins 103 only in the horizontal direction but is not pressed in the thickness direction of the workpiece 110 from the side at which the punch 101 is inserted, in other words, while the workpiece 110 is supported without being pressed.

Accordingly, the hole-forming process using the press machine is performed without pressing the workpiece in the thickness direction thereof, so that relief of the material in the horizontal direction, burrs around the holes, sticking of the material to the punch, etc., are prevented and high-pitch-accuracy, high-aspect-ratio small holes are formed.

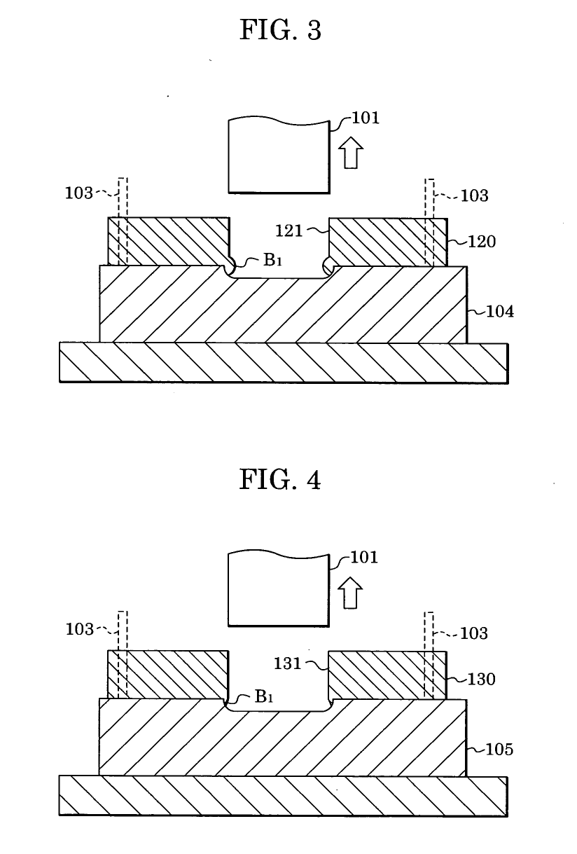

Alternatively, as shown in FIG. 3, a plate-shaped female mold 104 which is free from an opening for allowing the punch 101 to pierce therethrough may also be used. Also in this case, a small hole 121 is formed by moving the punch 101 downward while a workpiece 120 is positioned and fixed, but is not pressed, that is, while the workpiece 120 is supported without being pressed, similar to the above-described case. Accordingly, burrs B1 are particularly reduced in the hole-forming process, and high-aspect-ratio, high-pitch-accuracy small holes are formed efficiently.

With reference to FIG. 4, a female mold 105 is free from an opening and supports a workpiece 130 at the bottom surface thereof. The mold 105 has a Vickers hardness Hv in the range of 100 to 500, for example. In such a case, the burrs B1 are more effectively reduced in the hole-forming process and high-aspect-ratio, high-pitch-accuracy small holes are formed with a small load applied to the punch 101.

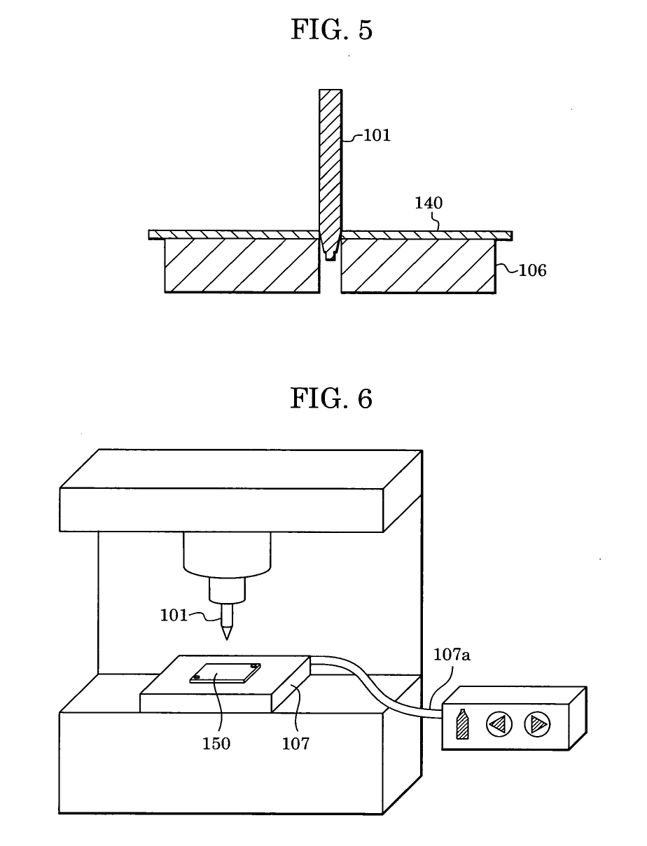

In addition, as shown in FIG. 5, in the hole-forming process, the bottom dead point of the punch 101 may be set below the bottom surface of a workpiece 140 placed on a female mold 106 having an opening. In such a case, the stability of the hole-forming process increases and holes having a uniform shape are formed in the workpiece 140 when seen from the side from which the punch 101 exits.

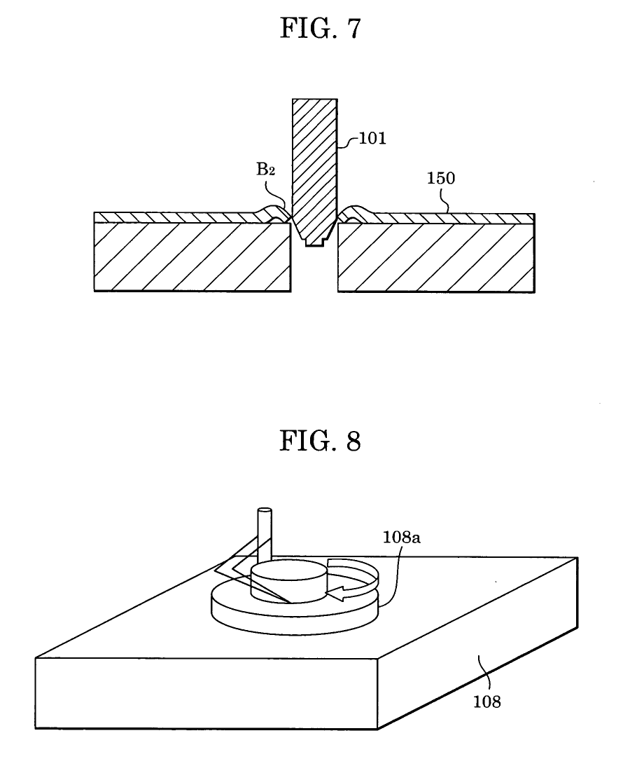

In addition, as shown in FIG. 6, a workpiece 150 may be fixed on a female mold 107 by suction using a suction device 107a in the hole-forming process. In such a case, the workpiece 150 is more effectively supported without being pressed, and strain B2, such as burrs, around the hole shown in FIG. 7 is prevented. Accordingly, hole-diameter accuracy and pitch accuracy of the holes are further increased.

### FIRST EXAMPLE

Holes were formed using the method shown in FIGS. 2A to 2C. A rolled nickel material (produced by Nilaco Corporation) with a thickness t=0.08 mm and a Vickers hardness Hv=210 was used as the workpiece 110, and a pair of holes with a diameter of 500 μm were formed at both ends as the positioning holes 110a. The positioning pins 103 on the stage 100 of the press machine, which serves as a hole-forming machine, were fitted in the respective positioning holes 110a, and thus the workpiece 110 was positioned and fixed without being pressed. The female mold (die) 102 having the die hole 102a was placed under the workpiece 110. A press tool obtained by grinding an ultra-fine grain cemented base material with a grain diameter of 0.7 μm was used as the punch 101, and the end diameter, the length of a straight portion, and the cone angle of a tapered portion adjacent to the straight portion of the press tool were 20 μm, 20 μm, and 25°; respectively.

A high-precision machining center (V33 produced by Makino Milling Machine Co., Ltd.) was used as the hole-forming machine for moving the punch 101 in the vertical direction, and the punch 101 was attached to a main shaft of the machine.

In the hole-forming process, the punch 101 attached to the main shaft of the hole-forming machine was moved in the vertical direction as shown in FIGS. 2A and 2B. The moving speed at which the punch was moved downward and upward was controlled at 2 mm/min. As shown in FIG. 2C, a hundred small holes (nozzles) 111 with a diameter of 20 μm and a depth of 80 μm (aspect ratio=4) were formed with a diameter accuracy of 20±1.0 μm and a pitch accuracy of 250±1.0 μm.

### SECOND EXAMPLE

Holes were formed using the method shown in FIG. 3. A nickel material with a thickness of 10 mm and a die-hole diameter of 0, that is, a nickel plate (produced by Nilaco Corporation) was used as the female mold (die) 104 which is free from an opening and was placed under the workpiece 120. The workpiece 120 was fixed to the nickel plate with the positioning pins 103, and small holes 121 were formed by moving the punch 101 in the vertical direction. Due to the plate-shaped female mold 104, the burrs B1 were suppressed from being formed on the side from which the punch exits in the hole-forming process and a nozzle plate having nozzles with a uniform shape was manufactured.

### THIRD EXAMPLE

As shown in FIG. 4, a plate-shaped female mold with a Vickers hardness Hv in the range of 100 to 500 was used as the female mold 105. If Hv is less than 100, a large number of burrs B1 are generated at the side from which the punch 101 exits in the hole-forming process. In addition, if Hv is more than 500, the punch 101 receives a large load and is easily broken or damaged. Accordingly, a brass plate with Hv=105 was used as the plate-shaped female mold 105. A hundred small holes 131 with a diameter of 20 μm and a depth of 80 μm (aspect ratio=4) were formed with a diameter accuracy of 20±1.0 μm and a pitch accuracy of 250±1.0 μm while keeping the number of burrs B1 as small as possible.

### FOURTH EXAMPLE

As shown in FIG. 5, a female mold 106 having an opening for setting the lower end of the movable area (bottom dead point) of the punch 101 below the bottom surface of the workpiece 140 was used, so that the punch 101 can completely pierce the workpiece 140. Accordingly, holes having a uniform shape were formed in the workpiece 140 when seen from the side from which the punch 101 exits, and the precision of the holes was increased. A hundred small holes with an aspect ratio of 4 were formed with a diameter accuracy of 20±0.8 μm and a pitch accuracy of 250±1.0 μm.

### FIFTH EXAMPLE

As shown in FIG. 6, small holes were formed in the workpiece 150 using a hole-forming machine having the female mold 107 and the suction unit 107a. A vacuum unit (produced by Fuji Engineering) was used as the suction unit 107a, and the workpiece 150 was held on the female mold 107 by suction using a vacuum tube such that the workpiece 150 was positioned and fixed without being pressed. Since the holes were formed while the workpiece 150 was fixed to the female mold 107 by suction, the strain B2 shown in FIG. 7 was prevented from occurring in the regions around the holes when the punch 101 is inserted, and the diameter accuracy and the pitch accuracy were increased. A hundred small holes with an aspect ratio of 4 were formed with a diameter accuracy of 20±0.6 μm and a pitch accuracy of 250±0.8 μgm.

### SIXTH EXAMPLE

As shown in FIG. 8, a nozzle plate having small holes, that is, nozzles, formed by the method used in the first example was polished using a high precision polishing machine 108 (MA-200D produced by Musashino Denshi Kabushiki Kaisha). In the polishing process, the nozzle plate was fixed to a φ100 holder with a two-sided adhesive tape (V-12-T produced by Nitto Denko Corporation). With respect to the polishing conditions, the load and the rotational speed were 1.0 kg and 40 rpm, respectively, and polycrystal diamond grains with a grain diameter of ½ μm were used as polishing grains. In addition, a tin/lead plate was used as a polishing disk 108a. The polishing process was performed for 30 minutes under the above conditions, and thus burrs generated in the hole-forming process were effectively removed and the shape accuracy of the holes was increased. Accordingly, a nozzle plate having small holes with an aspect ratio of 4, a circularity of 0.92, a diameter accuracy of 20±0.5 μm, and a pitch accuracy of 250±0.6 μm was obtained.

### SEVENTH EXAMPLE

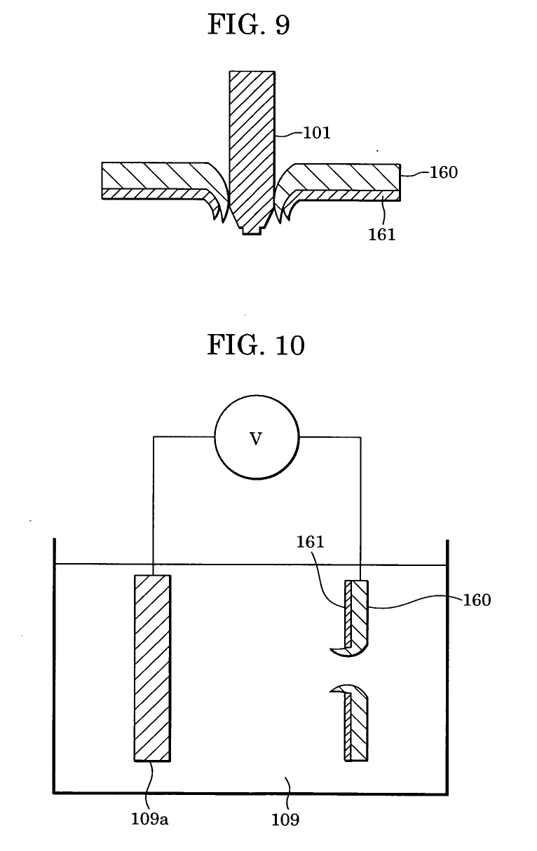

As shown in FIG. 9, holes were formed in a workpiece 160 similarly to the first example while a 25 μm thick dry film resist (Ordyl SY325 produced by Tokyo Ohka Kogyo Co., Ltd.) was adhered to the workpiece 160 as a dissolvable resist film 161 on the side from which the punch 101 exits.

Then, as shown in FIG. 10, the workpiece 160 in which the holes were formed in the above-described process and a platinum electrode 109a were immersed in an electric cell 109 as an anode and a cathode, respectively, and burrs were removed by applying an adequate voltage. The method of removing burrs by electropolishing uses a difference in surface energy between the metals, and the burrs are selectively dissolved since the current density in the burrs is particularly higher than that in other portions. For this reason, this method is effective for removing the burrs.

The electropolishing electrolyte in the electric cell 109 can be a mixture of 70 wt % glacial acetic acid and 30 wt % perchlorate, and the electropolishing process was performed using a potentiostat/galvanostat (HA501 produced by Hokuto Denko Corporation) at 10V for 2 min. The temperature differs depending on the composition of the electrolyte and the workpiece, but is normally in the range of room temperature to about 80° C. In the present example, the temperature was 50° C. Although the processing speed increases as the current density increases, a current density in a plateau region, in which gas is not generated, is used for ensuring stability.

Due to the above-described process, the burrs were removed and holes with smooth shapes were obtained. During this process, no current flowed in regions surrounding the holes since the resist film 161 was adhered to the workpiece 160, and these regions were prevented from being damaged.

The resist film 161 was removed using a resist-removing agent, and accordingly a nozzle plate having small holes, that is, nozzles, with an aspect ratio of 4, a circularity of 0.92, a diameter accuracy of 20±0.5 μm, and a pitch accuracy 250±0.6 μm was obtained.

The above-described hole-forming method according to the present invention may be applied not only to nozzle plates of liquid-discharge heads but also to various fields where small holes must be formed by press forming. Furthermore, in the above embodiments, the punch is moved towards engagement with the workpiece and the mold. Alternatively, the workpiece and the mold can be moved towards engagement with the tool.

While the present invention has been described with reference to what are presently considered to be the embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A method for forming holes in a workpiece, comprising the following steps:
providing a press tool and a female mold;
positioning the workpiece on the female mold in a horizontal direction with respect to the female mold;
restraining the workpiece on the female mold in the horizontal direction without pressing the workpiece in a thickness direction of the workpiece; and
press-forming holes in the workpiece by moving at least one of the press tool or the workpiece into engagement with each other.

2. The method according to claim 1, wherein the restraining step includes providing at least a pair of positioning holes in the workpiece and fitting at least a pair of positioning pins in the respective pair of positioning holes.

3. The method according to claim 1, wherein the providing step includes providing the female mold without an opening so that the press tool does not pierce the female mold therethrough.

4. The method according to claim 3, wherein providing the female mold without the opening includes providing the female mold composed of a material whose Vickers hardness (Hv) is in the range of about 100 to 500.

5. The method according to claim 1, wherein the restraining step includes restraining the workpiece by suction.

6. The method according to claim 1, further comprising providing a bottom surface of the workpiece with a dissolvable resist film.

7. The method according to claim 1, wherein the providing step includes providing the female mold with an opening so that the press tool pierces the female mold therethrough at the opening.

8. A component formed by the method according to claim 1.

9. A liquid-discharge head comprising:
a main unit having a plurality of discharge-energy-generating elements and a plurality of liquid flow paths facilitating ejecting liquid; and
a nozzle plate having a plurality of nozzles communicating with the liquid flow paths,
wherein the nozzles are formed by the method according to claim 1.
